(19) United States
(12) Patent Application Publication
(10) Pub. No.: US 2006/0115465 A1
(43) Pub. Date: Jun. 1, 2006

(54) Treatment of gastrointestinal disorders

(76) Inventors: George Macfarlane, Dundee (GB); Sandra Macfarlane, Dundee (GB); Elizabeth Furrie, Dundee (GB); John Cummings, Dundee (GB)

Correspondence Address: MYERS BIGEL SIBLEY & SAJOVEC, PO BOX 37428, RALEIGH, NC, 27627, US

(21) Appl. No.: 11/261,835

(22) Filed: Oct. 28, 2005

Related U.S. Application Data
(60) Provisional application No. 60/623,668, filed on Oct. 29, 2004.

(51) Int. Cl. A01N 63/00; A01N 65/00

(52) U.S. Cl. 424/93.46; 424/93.1; 424/93.4

(57) ABSTRACT

The present invention relates to the use of a therapeutic or nutraceutical composition for the treatment of a gastrointestinal disorder, namely ulcerative colitis. In addition, the present invention provides methods of treating subjects suffering from gastrointestinal disorders such as ulcerative colitis.

### CROSS REFERENCE TO RELATED APPLICATION

This application claims the benefit of U.S. Provisional Application Ser. No. 60/623,668, filed Oct. 29, 2004, entitled Treatment of Gastrointestinal Disorders, the disclosure of which is hereby incorporated herein by reference in its entirety as if set forth fully herein.

### FIELD OF THE INVENTION

The present invention relates to the use of a therapeutic or nutraceutical composition for the treatment of a gastrointestinal disorder, namely ulcerative colitis.

### BACKGROUND OF THE INVENTION

Ulcerative colitis (UC) is a relapsing inflammatory disease of the colon with unknown etiology. Evidence from animal models suggests that an altered immune response towards the commensal gut microbiota plays a role in the development and maintenance of this condition ⁽¹⁻⁵⁾. For example, knockout or transgenic mice with genetic susceptibilities to inflammatory bowel disease (IBD) only acquire characteristic lesions when their colon is populated with normal commensal bacteria, while germ-free animals do not manifest an inflammatory response ^{(6,7)}. Evidence from human studies has also suggested that mucosal bacterial populations in UC may be altered towards a more proinflammatory phenotype ^{(2,8-11)} Manipulation of the mucosal microbiota to reduce the inflammatory potential of colonizing bacteria is therefore an attractive therapy for UC. One option is to use antibiotics to remove species involved in inducing the inflammatory response. However, antibiotic therapy has had limited success in UC, possibly due to the fact that treatment needs to be customized for individual patients ⁽¹²⁻¹⁶⁾. An alternative is to use probiotic bacteria that interact with the host epithelium to resolve inflammation. Probiotics have been defined as live microbial feed supplements that beneficially affect the host by improving its intestinal microbial balance ⁽¹⁷⁾. The most widely used probiotics in humans are bifidobacteria and lactobacilli, but other organisms such as E. coli and the yeast Saccharomyces boulardii have been reported to have some beneficial effects in maintaining remission in inflammatory bowel disease (IBD) ⁽¹⁸⁻²⁰⁾. Few clinical trials have been made with probiotics to treat or maintain remission in IBD and the resulting success has been variable ⁽²¹⁻²⁴⁾. The best-known product, VSL#3, uses a mixture of eight different bacterial strains that have been reported to prevent the onset of pouchitis after pouch formation in UC patients ^{(25,26)}.

WO00/54788 discusses the use of a composition comprising lactic acid bacteria, a non-absorbable carbohydrate and a calcium salt and aluminum salt for the regeneration of the intestinal flora in the treatment of a number of gastrointestinal disorders.

### SUMMARY OF THE INVENTION

Embodiments of the present invention provide compositions and methods for treating gasterointestinal disorders including irritable bowel syndrome (IBS), delayed gastric emptying, gastroesophageal reflux disease (GERD), gastric ulcers, Crohn's disease, dyspepsia, opioid-induced bowel dysfunction, gastroparesis and ulcerative colitis. In some embodiments, the gastrointestinal disorder is ulcerative colitis.

Embodiments of the present invention further provide a pharmaceutical composition comprising at least one microorganism and a carbon source for enabling growth of the at least one microorganism in the digestive tract of a subject to which the pharmaceutical composition is administered. In some embodiments, the at least one microorganism is selected from the group consisting of Eschericia, Bacteroides, Lactobacillus, Clostridia and/or Bifidobacterium species. In other embodiments, the at least one microorganism is Bifidobacterium longum.

Embodiments of the present invention provide a pharmaceutical composition consisting essentially of (a) Bifidobacterium longum; (b) fructo-oligosaccharides; (c) inulin; and (d) a pharmaceutically acceptable carrier.

Embodiments of the present invention further provide a method of treating a subject suffering from ulcerative colitis, said method comprising (a) administering a therapeutically effective amount of at least one microorganism to a subject; and (b) administering a therapeutically effective amount of a carbon source to the subject; for enabling growth of the at least one microorganism in the digestive tract of the subject.

Embodiments of the present invention provide a method of treating a subject suffering from ulcerative colitis, said method comprising administering a pharmaceutical composition comprising at least one microorganism and a carbon source for enabling growth of the at least one microorganism in the digestive tract of the subject to which the composition is added, wherein the at least one microorganism is capable of modulating the production of cytokines from cells.

### BRIEF DESCRIPTION OF THE DRAWINGS

FIG. 1. Comparison of human [beta]-defensins (hBD) hBD2 (p<0.0001), hBD3 (p=0.0010), hBD4 (p<0.0001), TNF-α (p=0.0150), IL-1-α (p=0.0089)fz and IL-10 mRNA in UC rectal biopsies (n=18) versus normal rectal biopsies (n=12). Bars represent the mean +/−standard deviation, and results are normalized for epithelial cell numbers through expression levels of hBD1 for inducible hBD (2-4), and for total cells, through GAPDH levels for cytokines;

FIG. 2. hBD (2-4) and cytokine (TNF-α, IL-1-α, IL-10) mRNA concentrations in mucosal tissue before and after four weeks consumption of symbiotic or placebo. Bars represent means +/−standard deviation. All results shown for inducible hBD (2-4) are normalized for epithelial cell numbers, as determined by levels of hBD1, the constitutive epithelial cell house keeping gene, and cytokine levels are normalized for total cells per biopsy using GAPDH. Significance on comparison of pre and post-symbiotic groups were HBD2 (*p=0.0156), hBD3 (*p=0.0379), hBD4 (*p=0.0078), TNF-α (*p=0.0175), IL-1-α (*p=0.0379) and IL-10 (ns). Significance for comparison of the post symbiotic with post placebo group were HBD2 (ns), hBD3 (ns), hBD4 (ns), TNF-α (+p=0.0177), IL-1-α (+p=0.0051) and IL-10 (ns);

FIG. 3. Comparison of sigmoidoscopy scores (SS, scale 0-6) with inducible hBD mRNA synthesis (A) and histology score (HS, scale 0-3) with inducible hBD mRNA synthesis (B) in symbiotic patients (squares) and placebos (circles). Lines represent exponential best fits for synbiotic (broken lines) and placebo (solid lines) data sets, respectively;

FIG. 4. Representative histopathology of rectal mucosa from a UC patient pre-symbiotic therapy (A), and post-treatment (C), compared to a placebo patient at the start of the trial (B), and at the end of the study (D);

FIG. 5. Graph showing the effects of chilling (bacteria were stored at 4° C. in a refrigerator) for between 0 and 48 hours. The number of viable cells per ml⁻¹ was recorded;

FIG. 6. Graph showing the effect of bile concentration on the growth rate of three Bifidobacterial species; and

FIG. 7. Graph to show the effect of pH on the rate of growth of three Bifidobacterial species.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount. Unless otherwise defined, all terms, including technical and scientific terms used in the description, have the same meaning as commonly understood by one of ordinary skill in the art to which this invention belongs.

All publications, patent applications, patents, and other references mentioned herein are incorporated by reference in their entirety.

As used herein, a “therapeutically effective” amount refers to an amount that will provide some alleviation, mitigation, or decrease in at least one clinical symptom in the subject. Those skilled in the art will appreciate that the therapeutic effects need not be complete or curative, as long as some benefit is provided to the subject.

As used herein, a “nutraceutical” includes a natural and/or bioactive compound that has health promoting, disease preventing/treating and/or medicinal properties as understood by one of ordinary skill in the art.

By the terms “treating” or “treatment”, it is intended that the severity of the disorder or the symptoms of the disorder are reduced, or the disorder is partially or entirely eliminated, as compared to that which would occur in the absence of treatment. Treatment does not require the achievement of a complete cure of the disorder. Alternatively stated, the present methods slow, delay, control, or decrease the likelihood or probability of the disorder in the subject, as compared to that which would occur in the absence of treatment.

Embodiments of the present invention relate to the use of a therapeutic or nutraceutical composition for the treatment of a gastrointestinal disorder, namely ulcerative colitis. In addition, embodiments of the present invention provide methods of treating subjects suffering from other gastrointestinal disorders such as irritable bowel syndrome (IBS), delayed gastric emptying, gastroesophageal reflux disease (GERD), gastric ulcers, Crohn's disease, dyspepsia, opioid-induced bowel dysfunction, gastroparesis and other diseases and disorders of the gastrointestinal tract.

According to a first aspect of the present invention, there is provided a pharmaceutical composition comprising at least one microorganism and a carbon source for enabling growth of the microorganism(s) in the digestive tract of a subject to which the composition is administered, for use in treating ulcerative colitis. The at least one microorganism and the carbon source are included in a therapeutically effective amount to treat ulcerative colitis.

The microorganism is able to tolerate the environmental conditions within the digestive tract, and in some embodiments, the mammalian digestive tract, for example, the human digestive tract. The microorganism(s) may tolerate the conditions within the mouth, esophagus, stomach, small intestine (duodenum, jejunum and ileum), and colon. Conveniently the microorganism(s) tolerate the conditions in at least one of the mouth, esophagus, stomach, small intestine (duodenum, jejunum and ileum), and colon. Alternatively, the microorganisms may tolerate the conditions at a number of said digestive tract locations. In each of the above detailed regions, the levels of, for example, water, pH, bile, oxygen and nutrition may fluctuate, and consequently, it is beneficial for the microorganism to be able to tolerate varying levels of each of these factors.

The microorganism may tolerate conditions in which the oxygen content of the available atmosphere is low, for example, conditions in which the oxygen content is less that about 20% v/v or totally anaerobic conditions (0% oxygen v/v). In some embodiments, the microorganism is anaerobic or microaerophilic, and in this way, is able to tolerate both anaerobic conditions and conditions in which oxygen may be present.

The microorganism may exhibit a tolerance to acid. The levels of acid and alkalinity the microorganism may be able to tolerate correspond to the levels found throughout the digestive tract. Table 1 shows the approximate pH ranges at various points within the human digestive tract. It should be understood that these values represent mere indications of the pH in each section of the gut and these values may be subject to variation depending on various factors such as the health, nutritional status, age and geographical origin of the individual.

TABLE 1

| Location | pH | | |
|---|---|---|---|
| Mouth (saliva) | 5.7-7 | | |
| Esophagus | 7 | | |
| Stomach | 1.5-4 | | |
| Duodenum | 4-5 | | |
| Jejunum | 6-7 | | |
| Ileum | 6.5-7.5 | {close oversize brace} | Small intestine |
| Colon | 5.6-6.9 | | |

The microorganism may be able to tolerate a pH value from about pH 1 to about pH 8. The microorganism may be able to tolerate conditions in which the pH level is slightly acid or alkaline. A microorganism possessing the ability to tolerate the pH ranges found throughout the digestive tract, as substantially detailed above, may move through the digestive tract without being significantly affected by the pH levels encountered.

The microorganism may be tolerant to levels of bile. Bile is a complex solution comprising, for example acids, salts and lipids, and facilitates the breakdown and absorption of fat in the digestive tract. Bile is, however, toxic to many microorganisms, and consequently, it is desirable for the microorganism to exhibit a degree of bile tolerance. The level of bile it is desirable for the microorganism to tolerate may correspond to the levels of bile, which normally occur in each section of the digestive tract. By “normally occur” it is meant the level of bile, as found in each section of the digestive tract in a healthy human individual. For example post-prandially, the levels of bile in the small bowel of a subject may be highly variable, generally, however, the concentration of bile may range from approximately 5-10 mM. Consequently, it is desirable for the microorganism to be able to tolerate levels of bile which correspond approximately to these values. However, it should be understood that the concentration of bile may vary considerably from one individual to another and may also depend upon factors such as nutritional status and geographical origin of the subject.

The microorganism may bind or otherwise adhere to cells, for example, epithelial cells, and in some embodiments, colon epithelial cells. Microorganisms may bind by means of specialized surface structures, for example capsular polysaccharides, lipopolysaccharide, and/or outermembrane proteins for example, fimbriae/pili or flagella. By binding to cells, the microorganism may remain within the digestive tract of a subject despite the constant effects of peristalsis and subsequent movement of fluid through the gut lumen which might otherwise dislodge non-adherent microorganisms. The microorganism may have an affinity for the cells of the human digestive tract, and in particular, for the cells from the human colon.

The carbon source may selectively stimulate the growth of a particular microorganism. The carbon source may, for example, be any suitable compound that may be metabolized by the microorganism to allow it to grow so that it may establish a colony. The source of carbon may be provided in the form of a non-absorbable polymer. The carbon source may be provided in the form of, for example, a carbohydrate. The carbon source may be provided in the form of an oligosaccharide comprising a number of monosaccharides. Examples of oligosaccharides for use as a source of carbon may include, inulin, fructo-oligosaccharides and galacto-oligosaccharides. A single source or carbon, for example fructo-oligosaccharide, may be used to stimulate the growth of a particular bacteria, additionally or alternatively the source of carbon may comprise a combination of carbon sources, for example fructo-oligosaccharides and inulin. Alternatively, the source of carbon may comprise a combination of compounds, for example, a carbohydrate and a peptide as a means of stimulating the growth of a specific microorganism. An exemplary carbon source for use in the present invention, is “SynergyI™” which comprises a combination of fructo-oligosaccharides and inulin and may be obtained from Orafti, Tienen, Belgium.

The microorganism may be stable during storage. The microorganism may be stored for prolonged periods of time. The microorganism may be stored for prolonged periods of time without substantial loss of viability of the microorganism. The microorganism may be stored by any suitable means, for example, cold storage, storage in combination with a carbon source and freeze drying. The microorganisms may be stored at temperatures ranging from about −80° C. to about 4° C. In some embodiments, a substance, for example, glycerol may be added to facilitate the microorganism in surviving the freezing and/or cold storage process.

The microorganism may modulate the production of cytokines, for example, proinflammatory cytokines, from cells. Examples of proinflammatory cytokines, the production of which may be modulated by the microorganism may include Il-1α, TNF-α, Il-10 and 11-6. Many assays, known to the skilled artisan, are capable of being utilized for the detection of cytokine production. Such assays may include the use of cell cultures, and in some embodiments, cell culture monolayers for the detection of cytokine production. Using such a system, a microorganism may be contacted to the cell monolayer and incubated for a period of time. Samples of the cells or culture media in which the cells are growing may be obtained and subjected to a number of techniques that permit the detection of cytokines.

Methods of cytokine detection are well known in the art and may include, for example, immunodetection techniques for example, ELISA or Westernblot. Additionally or alternatively, techniques such as reverse transcriptase PCR, Southern and/or Northern blotting, as well as real-time PCR may also be used to detect the expression of cytokine production.

It is to be understood that the term “microorganism”, generally refers to microscopic organisms that can exist as a single cell or cell clusters. In particular embodiments of the present invention, microorganism represents a bacterial genus. Examples of bacteria capable of surviving the conditions of the digestive tract, as have been substantially described above, may include, for example, Escherichia, Bacteroides, Lactobacillus, Clostridia and/or Bifidobacterium species. In some embodiments, the microorganisms may test positive by Gram's method of staining, routinely used in the laboratory. Additionally, the microorganism(s) may be rod-shaped. In some embodiments, the microorganism may be of the Bifidobacterium genus. Examples of Bifidobacterium potentially useful in the presently described therapeutic composition may include Bifidobacterium adolescentis, Bifidobacterium bifidum, Bifidobacterium infantis, Bifidobacterium longum, Bifidobacterium angulatum, Bifidobacterium breve, Bifidobacterium catenulatum, Bifidobacterium dentium, Bifidobacterium lactis, Bifidobacterium pseudocatenulatum, Bifidobacterium suis and combinations thereof.

In some embodiments of the present invention, the therapeutic composition of the present invention comprises Bifidobacterium longum and a source of carbon suitable for enabling growth of Bifidobacterium longum in the digestive tract of a subject.

The microorganism may be administered in any suitable form, for example a microorganism culture may be combined with a food stuff, for example a dairy product, for example a yogurt, optionally in combination with said carbon source. Additionally, the carbon source may be administered separately.

In a second aspect of the present invention there is provided a method a treating a patient suffering from ulcerative colitis, said method comprising the steps of:
a) administering at least one microorganism to a subject; and
b) administering a carbon source to a subject; for enabling growth of the microorganism(s) in the digestive tract of the subject.

A single genera of microorganism may be administered to the subject, for example the microorganism may comprise one or more species from a single genus, for example Bifidobacterium or the microorganism may comprise a single bacterial species, for example, Bifidobacterium longum. Alternatively, the subject may be administered a “cocktail” of microorganisms from a number of different genera, for example Bifidobacterium, Lactobacillus, Eubacterium and Clostridium. By “cocktail” it is meant a therapeutic composition comprising at least two distinct species of microorganism.

Sufficient microorganisms are administered to the subject to maximize the number of organisms that survive the passage through the digestive tract. In some embodiments, about 2×10⁵ to about 2×10¹² microorganisms ml⁻¹ are administered to a subject, and in some embodiments, about 2×10⁸ to about 2×10¹², and in other embodiments, about 2×10⁹ to about 2×10¹¹ microorganisms ml⁻¹ are administered to the subject.

The carbon source may be administered in any suitable form. About 1-8 g of carbon source may be administered to a subject, and in some embodiments, 2-7 g, and in other embodiments, 3-6 g and in still further embodiments, 5-6 g of carbon source may be administered to a subject.

The microorganism may be administered to the subject after the consumption of a foodstuff or the like. In this way, the levels of acid within the stomach at least are reduced such that successful passage of the microorganism though the digestive tract may be facilitated. Additionally or alternatively, the level of acid within the digestive tract of the subject may be modulated by some other means, for example, the subject may first be provided with a solution or tablet comprising a basic substance, for example, calcium carbonate, which may act to lower the level of, for example, gastric acid.

The therapeutic substance is administered to the subject as often as it is required to establish colonization of the microorganism in the digestive tract, in particular, the colon of the subject. The therapeutic composition may be administered daily, for example, the therapeutic composition may be administered a number of times daily, for example, twice daily. The therapeutic composition may be administered to the subject for a number of days, for example the therapeutic composition may be administered for about 14-42 days, and in some embodiments, 21-35 days, and in other embodiments, for 28 days. It is to be understood that the number of days the therapeutic composition is administered and the number of times per day the therapeutic composition is administered may depend upon the individual subject and consequently is subject to variation.

In a third aspect of the present invention there is provided a therapeutic composition consisting essentially of a Bifidobacterium species and a carbon source for enabling growth of the Bifidobacterium in the digestive tract of a subject to which the composition is administered, for use in treating ulcerative colitis.

The Bifidobacterium species comprises Bifidobacterium longum and the carbon source for enabling growth of the Bifidobacterium longum comprises fructo-oligosaccharides and/or inulin.

In a fourth aspect of the present invention there is provided a use of a microorganism and a carbon source for enabling growth of the microorganism(s) in the digestive tract of a patient for the preparation of a medicament for the treatment of ulcerative colitis.

The therapeutic composition may be administered as two separate components, the first component comprising the microorganism or the carbon source and the second component comprising the other of the microorganism or the carbohydrate source. In some embodiments, the microorganism is administered to the subject and then the carbohydrate is administered to the subject.

For example, the carbon source may be administered to the patient by means of a nasal “drip feed” which would facilitate the direct delivery of the carbon source to the gut over a period of time. Such an approach would be particularly beneficial in severe cases of ulcerative colitis where a patient has become hospitalized. Additionally, patients who are unable to tolerate large doses of carbon source (for example, carbohydrate) may prefer to have less delivered over a longer period of time. In this way, the amount of carbon source delivered to the patient may be allowed to accumulate in the gut avoiding the need to administer a large amount of carbon source in a single dose. Alternatively, the carbon source may be provided as a form of food stuff, for example a cake, yogurt, bread/biscuit, energy bar or the like.

Alternatively, the therapeutic composition may be administered as a single preparation, wherein the preparation comprises the microorganism(s) and a carbon source. The microorganism may be isolated from the carbon source of the preparation by some means. For example, the microorganism may be encapsulated in a degradable capsule which permits delayed release of the organism within the digestive tract of the subject. Capsules suitable for encapsulation of the microorganism may include polymeric materials, for examples resins, waxes or gums for example gelatin, gum arabic or xanthan or for example may include liposomes.

Alternatively or additionally, the carbon source may also be isolated from the microorganism by means of a degradable capsule as substantially described above.

The preparation may be administered to the subject as often as is required to establish colonization of the microorganism in the digestive tract, in particular, the colon of the subject. Such administration regimes are substantially described above.

Subjects suitable to be treated according to the present invention include any mammalian subject in need of being treated according to the present invention. Human subjects of both genders and at any stage of development (i.e., neonate, infant, juvenile, adolescent, adult) can be treated according to the present invention. Mammalian subjects according to embodiments of the present invention include, but are not limited to, canines, felines, bovines, caprines, equines, ovines, porcines, rodents (e.g. rats and mice), lagomorphs, primates, humans, and the like, and mammals in utero.

The present invention is primarily concerned with the treatment of human subjects, but the invention can also be carried out on animal subjects, particularly mammalian subjects such as mice, rats, dogs, cats, livestock and horses for veterinary purposes, and for drug screening and drug development purposes.

Dosages will depend upon the mode of administration, the disease or condition to be treated, the individual subject's condition, and can be determined in a routine manner. See e.g., Remington, The Science And Practice of Pharmacy (20th Ed. 2000). In particular embodiments, more than one administration (e.g., two, three, four or more administrations) may be employed. Moreover, the compositions of the present invention can be administered in conjunction with other therapies for the treatment of gasterointestinal disorders including, but not limited to, irritable bowel syndrome (IBS), delayed gastric emptying, gastroesophageal reflux disease (GERD), gastric ulcers, Crohn's disease, dyspepsia, opioid-induced bowel dysfunction, gastroparesis and ulcerative colitis.

Exemplary modes of administration include oral, rectal, transmucosal, topical, transdermal, inhalation, intraperitoneal, intranasal, parenteral (e.g., intravenous, subcutaneous, intradermal, intramuscular, and intraarticular) administration, and the like, as well as direct tissue or organ injection. Injectables can be prepared in conventional forms, either as liquid solutions or suspensions, solid forms suitable for solution or suspension in liquid prior to injection, or as emulsions.

Embodiments of the present invention are further explained in detail with reference to the protocol presented below in the non-limiting example.

### EXAMPLE 1

### Materials and methods

Patients

Consecutive patients, with active UC, attending the Gastroenterology Outpatients Clinic, Ninewells Hospital, were asked to give written consent to take part in this investigation. Eighteen patients accepted the invitation. Eligible patients were aged 24-67 years who had not received antibiotics in the last three months, and were not taking commercially available probiotic preparations. Normal, healthy control biopsies were obtained from other patients attending the clinic, who had been shown by sigmoidoscopy and histology to have no evidence of inflammatory bowel disease. These studies were approved by the Tayside Committee on Medical Research Ethics, Dundee.

Study Design

Eighteen study numbers were assigned and randomized using a table of random digits ⁽³⁷⁾. Nine patient numbers were assigned to the test group, and nine to the placebo group. The 18 patients were randomly assigned to either group, and given a study number (SO1 to 18). This assignment was not divulged to the clinician, patient or in-house researcher who carried out the experimental measurements. A description of patient involvement is given in Table 1A, two patients did not attend the first study visit because they had taken antibiotics after recruitment such that 16 patients entered the study and their characteristics are given in Table 1B, Patients were recruited on the basis of active inflammation, time lag between recruitment and initiation of the study was up to 2 months. In one case (Table 1B), a placebo patient had entered remission after recruitment but before commencement of the study and had a sigmoioscopy score (SS) of 0 and a clinical activity index (CAI) of 1. Recruits were maintained on the therapy they were on at initiation of the trial and no therapy was altered during the study. Each patient was assessed in the IBD research clinic using the clinical activity index ⁽³⁸⁾ and sigmoidoscopic appearance scored ⁽³⁹⁾ as described in Table 2. They were also requested to keep a daily bowel habit diary, previously validated by J H Cummings ⁽⁴⁰⁾, in which details of the amount and consistency of each stool were recorded, together with the presence of blood or mucus and whether the subject experienced abdominal pain. Rectal biopsies were also taken for histology scoring by the Department of Pathology, Ninewells Hospital (no inflammation=0, mild inflammation=1, moderate inflammation=2, and severe inflammation=3). Venous bloods were taken for measurement of C reactive protein (CRP) (Biochemical Medicine, Ninewells Hospital). Further biopsies were used for in house assessment of mucosal inflammatory mediators. Test patients were given 2×10¹¹ freeze-dried viable Bifidobacterium longum in a gelatin capsule, and a sachet containing 6 grams of prebiotic fructo-oligosaccharide/inulin mix (Synergy I™, Orafti, Tienen, Belgium), twice daily for four weeks. Placebos were given in an identical capsule, containing potato starch, and sachets of six grams of powdered maltodextrose (Orafti), to simulate the prebiotic. The symbiotic/placebo was taken after breakfast, and following the evening meal to minimize inhibitory effects of gastric acid on the probiotic. At the end of one month, each patient was reassessed in the clinic and scored in the same way as the pretreatment visit. Biopsies were taken for histology and measurements of inflammatory markers, while C-reactive protein levels were done as before.

TABLE 1A
Description of patient involvement during the feeding study

| | Symbiotic | |
|---|---|---|
| | (9 starting patients) | Placebo (9 starting patients) |
| Pre-treatment | One removed (antibiotics) | One removed (antibiotics) |
| during study | No adverse responses | Two withdrew due to |
| | | deterioration of condition |
| | | (week 2) |
| Post-treatment | Remaining eight patients | Remaining six patients |
| | completed the study, seven | completed study, five |
| | with full biopsy retrieval | with full biopsy retrieval |

TABLE 1B
Clinical details of patients on commencement of therapy, mean (range).

| | Symbiotic | Placebo |
|---|---|---|
| | (8 starting patients) | (8 starting patients) |
| Age (y) | 45(24-66) | 38(26-59) |
| M:F | 3:5 | 5:3 |
| Duration of disease (y) | 10(1-23) | 7(1-15) |
| Disease extent* | | |
| Total | 3 | 2 |
| Left sided | 4 | 3 |
| Proctosigmoid | 1 | 2 |
| Current drugs** | | |
| Steroids | 5 | 5 |
| Immunosuppressants | 6 | 6 |
| 5-ASA | 5 | 5 |
| Initial Clinical Activity | 5.6(2-13) | 4.7(1-8) |
| Index | | |
| Initial sigmoidoscopy | 4.4(2.5-6.0) | 2.9(0-6) |
| score | | |
| Initial CRP mg/l | 6.0(0-16) | 5.5(0-17) |

*Disease extent unknown for one placebo patient
**Ulcerative colitis related drugs only

TABLE 2
System used to score inflammation in the colon at
sigmoidoscopy (modified from Baron⁽³⁹⁾

| | 0 | 1 | 2 |
|---|---|---|---|
| Feeding | None | On touching mucosa | — |
| Bleeding | No blood | Blood in lumen | — |
| Vessel pattern | Normal | Some patchy changes | All vessels obscured |
| Overall | Normal | Moderate change | Severe active |
| appearance | | | disease |

Production of the Probiotic

Nineteen different bifidobacterial isolates were assessed for suitability as a probiotic strain (10 were isolated from healthy colonic mucosae, five were obtained from feces of healthy donors and four were culture collection strains). They comprised, six strains of B. adolescentis, two B. bifidum, two B. infantis (DSM 86184, ATCC 15617) two B. longum, and one each of B angulatum, B. breve, B. catenulatum, B. dentium, B. lactis (DSM 10140), B. pseudocatenulatum and B. suis (ATCC 17533). The organisms were assessed for aerotolerance, acid tolerance, bile salt resistance, adhesion to epithelial cells, and their abilities to utilize oligofructose as an energy source. Their abilities to survive freeze drying and long-term storage were also determined. The organism which performed best in all cases was a B. longum strain isolated from healthy rectal mucosa. Its identity was confirmed by partial sequencing (500 of 1500 bp) of the variable region of the 16S rRNA gene. Further analysis of the ability of the selected organism to alter the profile of cytokine expresssion in a model epithelial cell line (HT29) was investigated. Proinflammatory cytokine IL-1-α was measured by both real-time PCR for mRNA levels and cytokine ELISA for secreted proteins, either alone or in co-culture with the selected B. longum, B. bifidum and a commensal Escherichia coli. The selected probiotic was found to significantly reduce IL-1-α produced by HT-29 cells with respect to mRNA levels (p<0.05) and protein (p<0.05), unlike the other two organisms, which increased expression of this proinflammatory cytokine. The organism was subsequently grown overnight in batch culture under anaerobic conditions at 37° C., in Wilkins-Chalgren (WC) broth. Bacteria were harvested by centrifugation (14,000 g, 30 min) and washed twice in anaerobic phosphate buffered saline. The pellet was frozen overnight at −80° C., then lyophilized (Modulyo Bench Top Freeze Dryer, Thermo Savant, Holbrook, N.Y., USA). The resulting powder was weighed, and in order to determine cell viability and check purity, serial dilutions were made and plated onto WC agar plates. These were incubated aerobically and anaerobically to maximize contaminant detection. All quantitation and purity tests were checked by two independent microbiologists during production and packaging of the probiotic.

RNA and cDNA Preparation

Biopsies were mascerated using liquid nitrogen snap freezing, and mechanical grinding. RNA was purified using the RNA easy kit (Qiagen, Hilden, Germany), with an initial clean-up stage using a Qiashredder column (Qiagen), and an additional step of DNA digestion to ensure no genomic DNA contamination. The samples were reverse transcribed using the AMV RT kit (Promega, Madison, Wis., USA) as per the manufacturers instructions, and were aliquoted before storage at −80° C.

Preparation of Standards for Quantitation of DNA

Standard amounts of DNA corresponding to the target sequences are needed to carry out real-time PCR. This was achieved by making purified plasmid DNA containing the target sequences using techniques known to those skilled in the art. Briefly, cDNA from normal healthy colon, or mononuclear blood cells, was amplified using the specific PCR primer pair (see table 3). Product of correct size and sequence was purified using the Qiaquick PCR purification kit (Qiagen), and ligated into a vector using the pGEM-T easy vector system I (Promega). JM109 competent E. Coli (Promega) were transformed with each ligated vector, and after overnight incubation, positive colonies were chosen. From each selected colony, the plasmid was purified using the Wizard plus SV miniprep system (Promega). Concentration of the plasmid preparation was determined by agarose gel electrophoresis, with known standards (New England Biolabs, Beverly, Mass., USA). The samples were diluted to 10¹⁰ molecules/ml aliquoted and stored

(−80° C.).

Real-Time Quantitative PCR

The appropriate plasmid preparation was diluted to give a standard curve of 10⁶-10¹ molecules/μl for all assays, except GAPDH, which had a standard curve of 10⁸-101 molecules/μl. Real-time PCR was carried out using an iCycler and the iQ SYBR Green Supermix (BioRad, Hercules, Calif., USA). Test samples were added in triplicate at 2 μl/well in a 20 μl total reaction volume.

Histopathology

Tissue specimens were fixed in formalin and embedded in paraffin. Four micron thick sections were cut using a microtome (Leica RM 2135) and mounted onto clean glass slides, which had been coated with poly-L-lysine (Superfrost plus, VWR International Ltd, Poole, Dorset, UK) to improve tissue adherence. Four serial sections were stained with hematoxylin and eosin, using standard methods, to visualize tissue morphologies.

Statistics

Significant differences between pre-symbiotic and post-symbiotic therapy groups and between the post-symbiotic and post-placebo groups were assessed for hBD and cytokine results using the Mann Whitney test for non-parametric analysis, since the data were not normally distributed. Significant difference in the clinical outcome was assessed using the difference in SS in the symbiotic group over 4 weeks when compared to the difference in SS in the placebo group using a two sample t test with equal variances. Significance was given for p values less than 0.05.

### EXAMPLE 2

### Results

Effect of Freeze Drying on Cell Viability

Table 3 below shows the number of viable bacteria recovered after being subjected to freeze drying.

TABLE 3
Effects of freeze drying on cell viability

| Before freeze-drying | After freeze drying | Mean recovery (%) |
|---|---|---|
| 40 ± 52 × 10¹² | 25 ± 23 × 10¹² | 62.5 |

Results are mean tests on three separate batches ±SD.
Aerotolerance of Different Bifidobacteria at 37° C.

Table 4 below compares the ability of six Bifidobacteria species to grow in either anaerobic, microaerophilic and aerobic conditions.

TABLE 4
Aerotolerance of different Bifidobacteria at 37° C.

| Mucosal Bifidobacterium | Anaerobic | Microaerophilic | Aerobic |
|---|---|---|---|
| isolate | growth¹ | growth² | growth² |
| B. longum | +++++ | +++ | +++ |
| B. breve | +++++ | +++ | − |
| B. bifidum | +++++ | ++ | − |
| B. angulatum | +++++ | +++ | − |
| B. pseudolongum | +++++ | − | − |
| B. adolescentis | +++++ | − | − |

¹Anaerobic chamber
²Gas jar
³Aerobic incubator

Inflammatory Makers in Healthy and UC Tissues

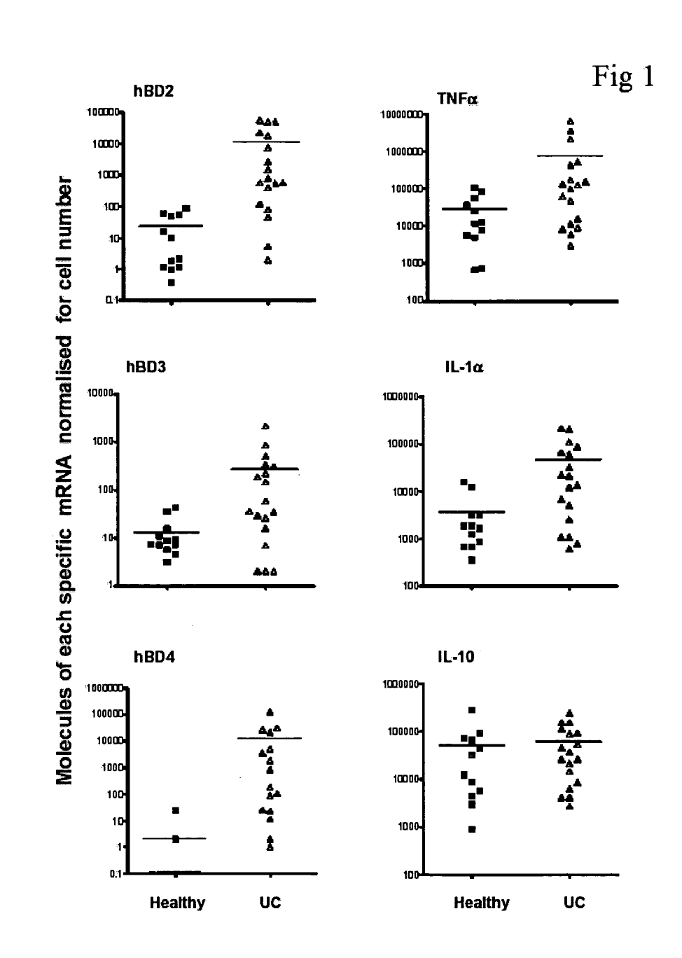

All results shown for inducible hBD (2-4) are normalized for epithelial cell numbers, as determined by levels of HBD1, the constitutive epithelial cell house-keeping gene. FIG. 1 shows that there were significant increases in mRNA expression for all inducible defensins measured (hBD2 p<0.0001, hBD3 p=0.0010, hBD4 p<0.0001) in UC rectal biopsies (n=18) compared to normal healthy rectal biopsies (n=12). Analysis of the pro-inflammatory cytokines TNF-α and IL-1-α were also significantly increased in UC compared with normal controls (p=0.0150 and p=0.0089, respectively), while there was no significant difference in the immunomodulatory cytokine IL-10.

Effect of Symbiotic on Inflammatory Markers in the Gut

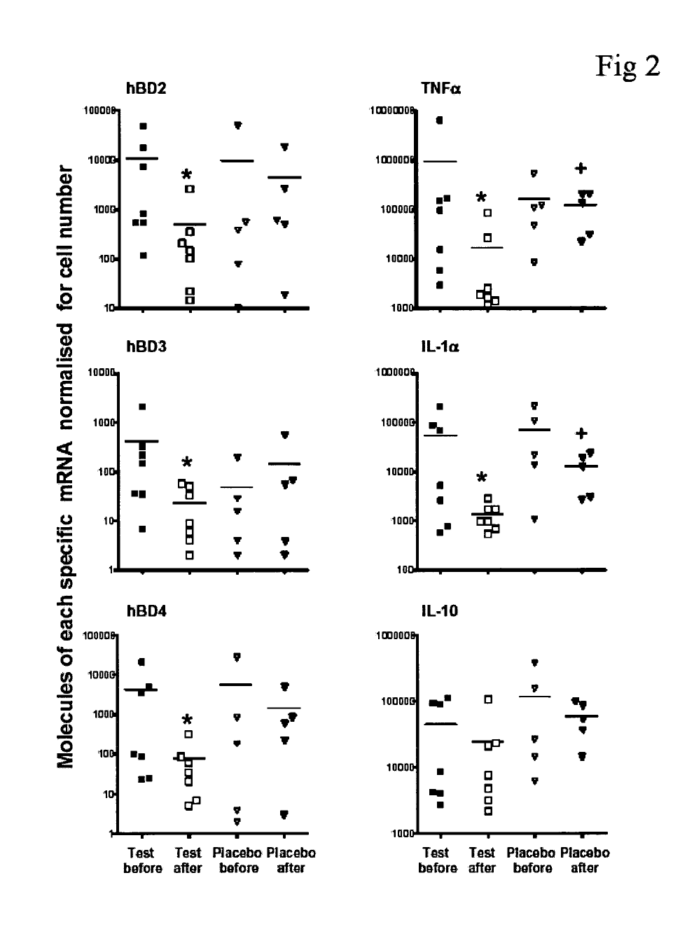

FIG. 2 shows results from the two trial groups, before and after the four week feeding period. Significant differences in expression of inducible hBD occurred in the symbiotic patients (hBD2 p=0.0156, hBD3 p=0.0379, hBD4 p=0.0078). No significant differences between the post-symbiotic group and the post-placebo were observed for hBD, due to the small number of placebos who completed the trial. Similar results were obtained for the proinflammatory cytokines TNF-α and IL-1-α, with significant reductions in expression in the post-feeding symbiotic patients compared with the pre-symbiotic group (p=0.0175 and p=0.0379, respectively). On comparison of the levels of inflammatory cytokines for the post symbiotic group versus the post placebo group, a significant reduction for both TNF-α and IL-1-α levels was observed (p=0.0177 and p=0.0051, respectively). A marked reduction was seen with IL-1-α, which returned to levels found in normal healthy tissue (see FIG. 1). No significant difference was seen in IL-10 between either the placebos or the symbiotic group.

Presence of Bifidobacteria on the Mucosa

Levels of bifidobacterial specific total rRNA was determined using real-time PCR in mucosal biopsies pre and post-treatment. The symbiotic group had a starting mean of 1406 molecules of bifidobacterial rRNA per biopsy, which rose to a mean of 58699 at the end of the study, a 42-fold increase. The placebo group had a mean starting level of 3527 bifidobacterial rRNA copies per biopsy increasing to 16285 over the same four week interval, a 4.6-fold increase. The samples were normalized by number of epithelial cells by hBD 1 levels.

Clinical Outcome

Clinical outcome for patients assessed by sigmoidoscopy score (SS), Clinical activity index (CAI) and bowel habit index (BHI). The results are expressed as the difference in values recorded at day 1 and day 28 of the trial for SS and CAI, and as the percentage change over the four week period for the BHI. SS (maximum change possible=6) was decreased by a mean of 1.3 points over the four week period in the symbiotic group (n=8), five patients improved, two remained the same and one increased from 4 to 5. The placebo group had an increase of 0.58 over the same period (n=6), three had increased scores, and three had decreased scores. SS were reduced markedly in the symbiotic group after treatment (start 4.5+/−1.4, finish 3.1+/−2.5) when compared to the placebos n=6 (start 2.6+/−2.1, finish 3.2+/−2.2). The difference in pre and post-feeding between the symbiotic and placebo groups was borderline significant (p=0.06). CAI (maximum score 19) was reduced in 5 patients in the symbiotic group with 3 showing an increase in score (start 5.6+/−3.7, finish 5.3+/−3.4). Placebo group had 3 patients with improving scores one which remained the same and two with increased CAI (start 4.9+/−3.2, finish 3.1+/−2.5). The mean percentage BHI increased in the placebo group by 70.4 when compared to a reduction of 20.4 percent in the symbiotic group.

Correlation of hBD Levels with Sigmoidoscopy Scores (SS)

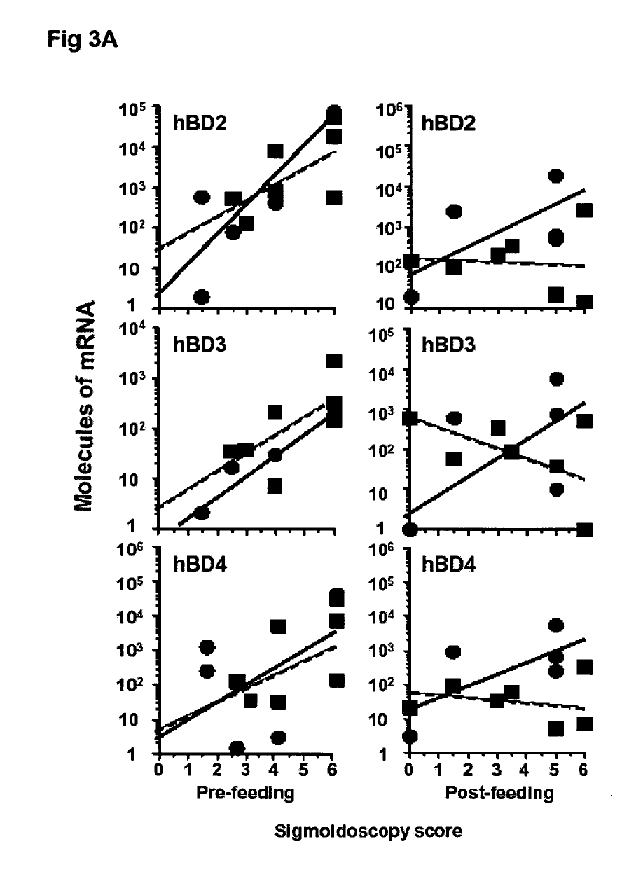

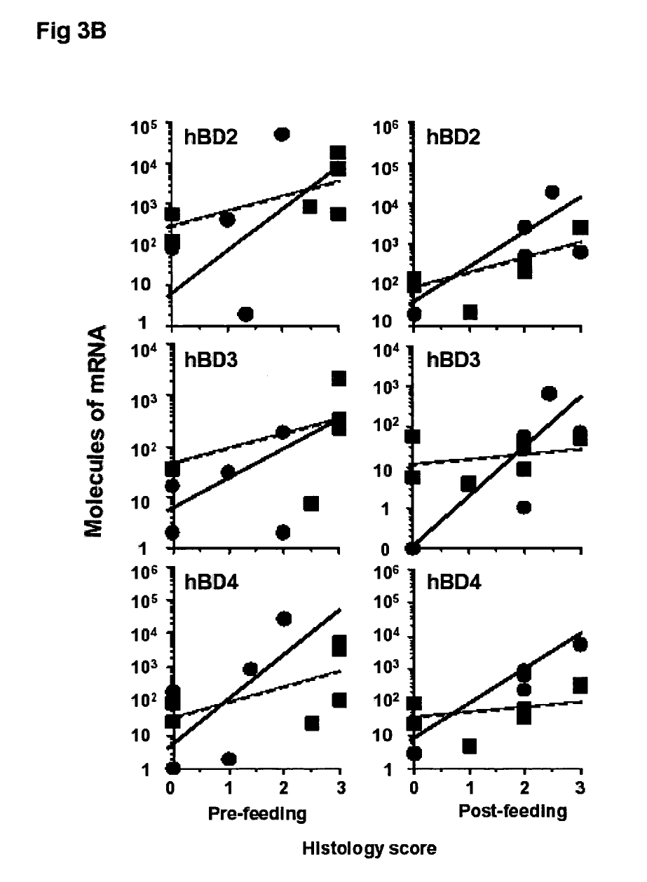

Analysis of the relationship between SS and levels of individual hBD showed that there was no correlation between hBD1 with SS, before or after treatment, in either the test or placebo group (results not shown). However, in both symbiotic and placebo groups pre-treatment, there was a positive correlation between SS and mRNA for hBD2-4, whereby in more active disease, higher levels of inducible hBD were detected (FIG. 3A). At the end of the feeding study, comparison of SS and hBD showed that this positive correlation remained only in the placebo group, whereas hBD2 and hBD4 manifested a loss of correlation with SS score, and hBD3 had an inverse relationship in the symbiotic group.

Correlation of hBD Levels with Histology Scores (HS)

A positive correlation was evident in the relationship between HS and hBD2-4, in both symbiotic and placebo groups, before the feeding study (FIG. 3B). After treatment, the placebos retained a positive correlation for all three inducible beta defensins, as occurred with SS. In the symbiotic group, a positive correlation for hBD2 and 4 remained, when comparing HS with mRNA concentrations, however, hBD3 levels related poorly with HS in this group (FIG. 3B).

C-Reactive Protein (CRP) Levels in Blood

Only five of the eight symbiotic patients had elevated CRP (mean 6.0, SD 6.5), and only one of the six patients in the placebo group who completed the study had elevated CRP (mean 1.6, SD 3.6). After treatment, the symbiotic group showed a reduction in CRP (mean 1.8, SD 3.9), after four weeks, none of the placebo patients had raised circulating levels of CRP.

Histopathology of Rectal Biopsies

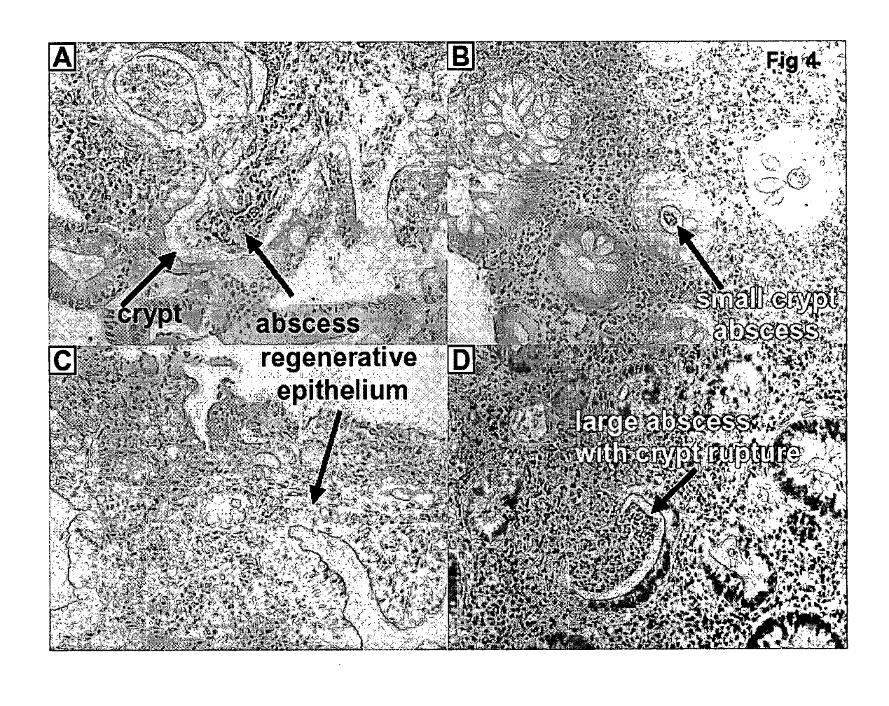

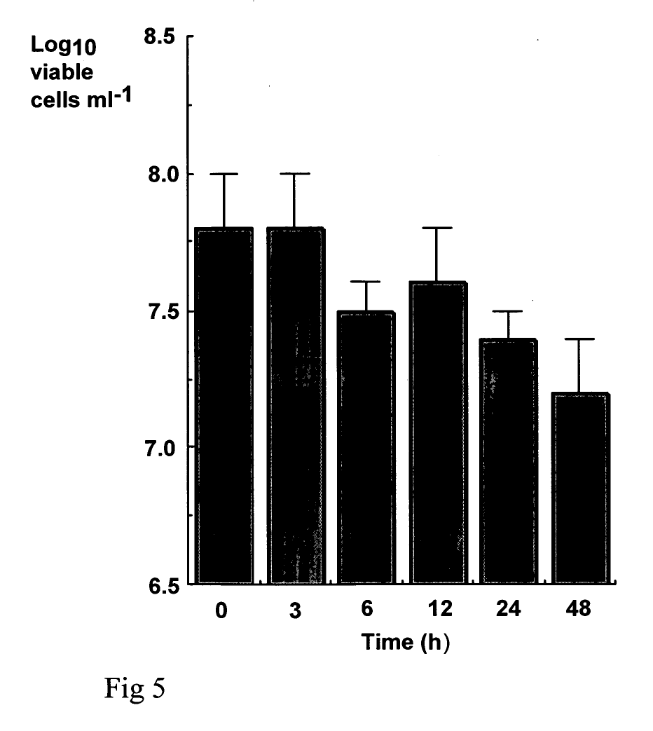

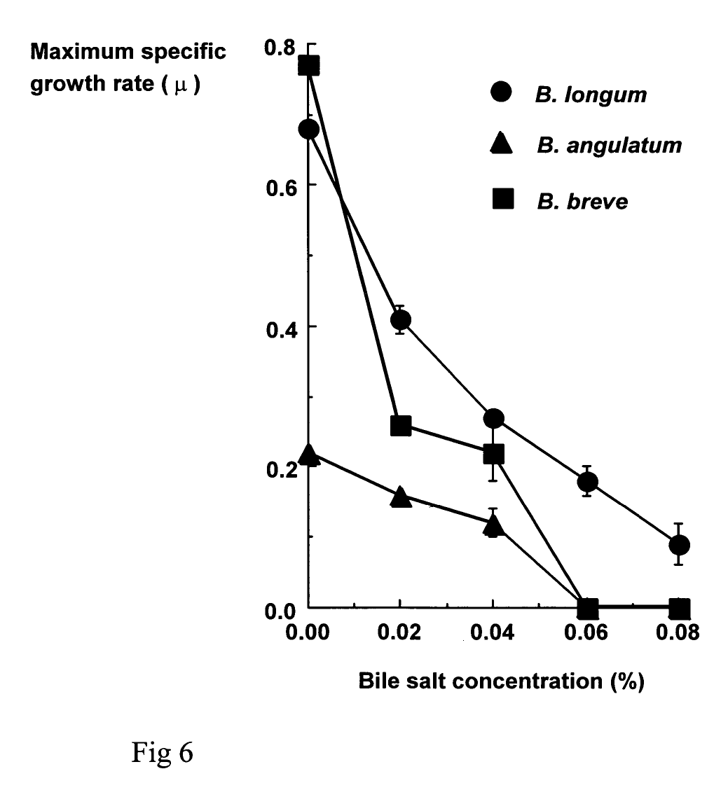

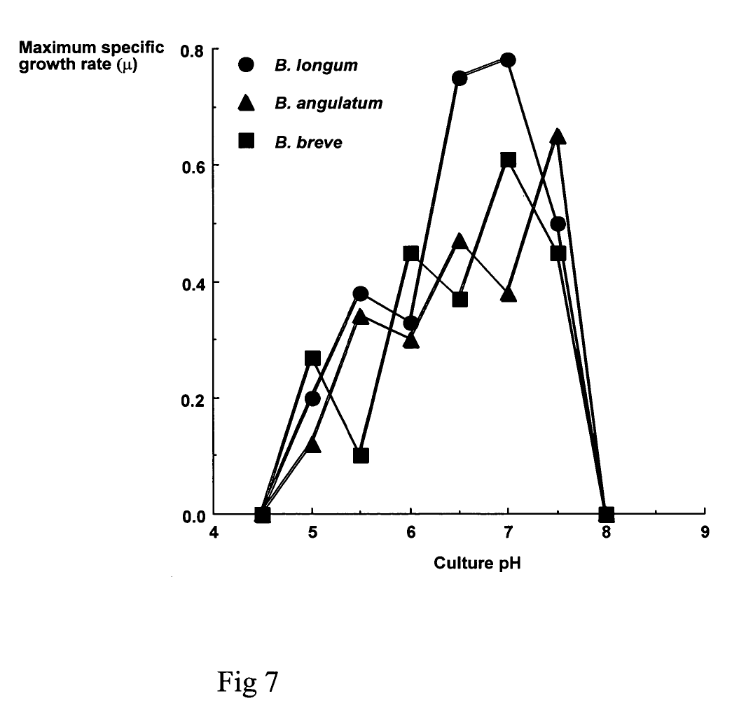

Histology scoring produced results similar to the sigmoidoscopy score, 4 individuals showed a reduction in score and 2 remained the same with a mean reduction in histology score in the symbiotic group over the 4 week period (start 1.7+/−1.4 finish 1.1+/−1.2) when compared to mean increase in the placebo group (start 0.9+/−0.9 finish 1.9+/−1.1) with 3 showing an increase in score and 2 remaining the same. Two representative paired biopsies are shown in FIG. 4: A (SS=6, HS=3) and C(SS=3.5, HS=1.5) were from a symbiotic patient, pre- and post-feeding, respectively, while B (SS=1.5, HS=1.5) and D (SS=5.0, HS=2.5) were from a placebo treated patient, at the beginning and end of the study. Comparison of A and C shows resolution of acute inflammatory activity following symbiotic consumption. The crypt abscesses in A have disappeared, and the epithelium shows a more regenerative appearance in C. Small crypt abscesses are evident in the rectal biopsy from placebo (B). This inflammation has been exacerbated in D, with a larger abscess visible in the middle of the section, with crypt rupture and a general increase in the numbers of infiltrating cells.

Consumption of symbiotic twice daily over four weeks reduced mucosal inflammatory markers in active UC. This was concurrent with a reduction in colitis at the macroscopic and microscopic level. However, although lowered sigmoidoscopy scores were observed in the symbiotic group, they were not as marked as the reductions in HS and inflammatory markers. This may indicate that changes in inflammatory mediators at the molecular level could precede gross clinical changes scored through sigmoidoscopy by several weeks. Markers of active disease in biopsies from UC patients include pro-inflammatory cytokines such as TNF-α, IL-8, IL-1-α and IL-1-β ⁽²⁹⁾. These molecules are up-regulated in active UC, but they are not specific for the epithelium, since the large numbers of infiltrating leukocytes in the mucosa contribute greatly to their formation ^{(28.30)}. When using a probiotic or symbiotic, it is desirable to be able to assess directly its effects on the epithelial barrier as well as the underlying immune system, since the epithelium is the first point of host contact for the organisms.

A newly described group of anti-microbial peptides known as human beta defensins (hBD) are expressed uniquely by epithelial cells. Six hBD (hBD1-6) are currently recognised. hBD1 is constitutively expressed, therefore the level of expression of HBD1 mRNA directly allows an absolute determination of the number of epithelial cells in each biopsy ⁽³¹⁻³⁾. hBD2 and 3 have been shown to be significantly upregulated in UC, but not in Crohn's disease ⁽³⁴⁻³⁶⁾ and are good target genes for assessing inflammatory responses in UC epithelia. hBD2-4 are up-regulated by bacterial challenge and pro-inflammatory cytokines ^{(33, 34, 41)}. These molecules are produced by the inflammatory infiltrate and by the epithelium itself ⁽³⁰⁾ directly affecting the expression levels of inducible hBD in epithelial cells. IL-1 has been shown to induce upregulation of hBD2 in gastric and colonic epithelial cell lines ^{(34,41)}.

From studies described herein, a direct relation between mRNA synthesis for inducible hBD and severity of UC (SS) has been shown for the first time, together with the relationship between inducible hBD and histology scores in UC patients. The functions of these induced hBDs are unknown in UC disease progression. However, hBD are anti-microbial peptides that may destroy gram-negative bacteria ⁽³³⁾ so their production may be an attempt by the epithelium to modify the composition of the mucosal biofilm. The bifidobacterial probiotic strain used in embodiments of the present invention was found to be insensitive to hBD-mediated killing by recombinant hBD 1, 2 and 3 (results not shown), therefore, as a part of a therapy for UC, this organism may exhibit better survival characteristics on the inflamed mucosa, and interact directly with the epithelial surface and modify the immune response. Higher numbers of total bifidobacteria on the mucosal surface in patients fed the symbiotic, compared to those taking the placebo were observed.

Accordingly, the present invention provides that symbiotics may be developed into acceptable therapies for patients suffering from ulcerative colitis, and in particular, acute UC.

### REFERENCES

1. Macdonald T T, Monteleone G, Pender S L F. Recent developments in the immunology of inflammatory bowel disease. Scand J Immunol 2000;51:2-9.

2. Campieri M, Gionchetti P. Bacteria as the cause of ulcerative colitis. Gut 2001;48:132-35.

3. Schultsz C, Van Den Berg F M, Ten Kate F W, et al. The intestinal mucus layer from patients with inflammatory bowel disease harbors high numbers of bacteria compared with controls. Gastroenterology 1999;117:1089-97.

4. Butcher E C. Leukocyte-endothelial cell recognition: three (or more) steps to specificity and diversity. Cell 1991;67:1033-36.

5. Duchmann R, Kaiser I, Hermann E, et al. Tolerance exists towards resident intestinal flora but is broken in active inflammatory bowel disease (IBD). Clin Exp Immunol 1995;102:448-55.

6. Sadlack B, Merz H, Schorle H. Ulcerative colitis-like disease in mice with a disrupted interleukin-2 gene. Cell 1993;75:253-61.

7. Taurog J D, Richardson J A, Croft J T, et al. The germ free state prevents development of gut and joint inflammatory disease in HLA-B27 transgenic rats. J Exp Med 1994;180:2359-64.

8. Matsuda H, Fujiyama Y, Andoh A, et al. Characterisation of antibody responses against rectal mucosa-associated bacterial flora in patients with ulcerative colitis. J Gastroenterol Hepatol 2000; 15:61-8.

9. Hartley M G, Hudson M J, Swarbrick E T, et al. The rectal mucosa associated microflora in patients with ulcerative colitis. J Med Microbiol 1992;36:96-103.

10. Poxton I R, Brown R, Sawyer A, et al. Mucosa-associated bacterial flora in the human colon. J Med Microbiol 1997;46:85-91.

11. Macfarlane S, Furrie E, Cummings J H, et al. Chemotaxonomic analysis of bacterial populations colonizing the rectal mucosa in patients with ulcerative colitis. Clin Infect Dis 2004 (In press).

12. Dickinson R J, O'Connor H J, Pinder I, et al. Double blind controlled trial of oral vancomycin as adjunctive treatment in acute exacerbations of idiopathic colitis. Gut 1985;26:1380-84.

13. Mantzaris G J, Hatzis A, Kontogiannis P, et al. Intravenous tobramycin and metronidazole as an adjunct to corticosteroids in acute, severe ulcerative colitis. Am J Gastroenterol 1994;89:43-6.

14. Turunen U M, Farkkila M A, Hakala K, et al. Long-term treatment of ulcerative colitis with ciprofloxacin: a prospective, double-blind, placebo-controlled study. Gastroenterology 1998;115:1072-78.

15. Present D H. Ciprofloxacin as a treatment for ulcerative colitis-not yet. Gastroenterology 1998;115:1289-91.

16. Cummings J H, Macfarlane G T. Is there a role for microorganisms? In: Jewell D P, Warren B F, Mortensen N J, eds. Challenges in inflammatory bowel disease. First edition. Oxford: Blackwell Science, 2001:47-8.

17. Macfarlane G T, Cummings J H. Probiotics, infection and immunity. Curr Opin Infect Dis 2002;15:501-06.

18. Kruis W, Schutz E, Fric P, et al. Double blind comparison of an oral Escherichia coli preparation and mesalazine in maintaining remission of ulcerative colitis. Aliment Pharmacol Ther 1997;11:853-58.

19. Rembacken B J, Snelling A M, Hawkey P M, et al. Non-pathogenic Escherichia coli versus mesalazine for the treatment of ulcerative colitis: a randomised trial. Lancet 1999;354:635-39.

20. Guslandi M, Mezzi G, Sorghi M, et al. Saccharomyces boulardii in maintenance treatment of Crohn's disease. Dig Dis Sci 2000;45:1462-64.

21. Roberfroid M. Prebiotics and symbiotics: concepts and nutritional properties. BJN 1998;80:S197-S202.

22. Venturi A, Gionchetti P, Rizzello F, et al. Impact on the composition of the faecal flora by a new probiotic preparation: preliminary data on maintenance treatment of patients with ulcerative colitis. Aliment Pharmacol Ther 1999;13:1103-08.

23. Prantera C, Scribano M L, Falasco G, et al. Ineffectiveness of probiotics in preventing recurrence after curative resection for Crohn's disease: a randomised controlled trial with Lactobacillus G G. Gut 2002;51:405-9.

24. Laake K O, Line P D, Aabakkan L, et al. Assessment of mucosal inflammation and circulation in response to probiotics in patients operated with ileal pouch anal anastomosis for ulcerative colitis. Scand J Gastroenterol 2003;38:409-14.

25. Hart A L, Stagg A J, Kamm M A. Use of probiotics in the treatment of inflammatory bowel disease. J Clin Gastroenterol 2003;36: 111-19

26. Gionchetti P, Rizzello F, Helwig U, et al. Prophylaxis of pouchitis onset with probiotic therapy: a double blind, placebo controlled trial. Gastroenterology 2003;124:1202-09.

27. Mimura T, Rizzello F, Helwig U, et al. Once daily high dose probiotic therapy (VSL#3) for maintaining remission in recurrent or refracrory pouchitis. Gut 2004;53:108-14

28. Borruel N, Carol M, Casallas F, et al. Increased mucosal tumour necrosis factor a production in Crohn's disease can be down regulated ex vivo by probiotic bacteria. Gut 2002;51:659-64.

29. Woywodt A, Ludwig D, Neustock P, et al. Mucosal cytokine expression, cellular markers and adhesion molecules in inflammatory bowel disease. Eur J Gastroenterol Hepatol 1999; 11:267-76.

30. Daig R, Rogler G, Aschenbrenner E, et al. Human intestinal epithelial cells secrete interleukin-1 receptor antagonist and interleukin-8 but not interleukin-1 or interleukin-6. Gut 2000;46:350-58.

31. Zhao C, Wang I, Lehrer R I. Widespread expression of beta defensin hBD-1 in human secretory glands and epithelial cells. FEBS Lett 1996;396:319-25.

32. Yamaguchi Y, Nagase T, Makita R, et al. Identification of multiple novel epididymis specific beta-defensin isoforms in humans and mice. J Immunol 2002;169:2516-23.

33. O'Neil D A. Regulation of expression of beta-defensins: endogenous enteric peptide antibiotics. Mol Immunol 2003;40:445-50.

34. O'Neil D A, Porter E M, Elewaut D, et al. Expression and regulation of the human betadefensins hBD-1 and hBD-2 in intestinal epithelium. J Immunol 1999;163:6718-24.

35. Wehkamp J, Harder J, Weichenthal M, et al. Inducible and constitutive beta defensins are differentially expressed in Crohn's disease and ulcerative colitis. Inflamm Bowel Dis 2003:9:215-23.

36. Fellerman K, Wehkamp J, Herrlinger K R, Stange E F. Crohn's disease: a defensin deficiency syndrome? Eur J Gastroenterol Hepatol 2003; 15:627-34.

37. Daniel W W. Biostatistics: A foundation for analysis in the health sciences. Fourth edition, New York: John Wiley and Sons Inc, 1987:689.

38. Walmsley R S, Ayres R C S, Pounder R E, et al. A simple clinical colitis activity index. Gut 1998; 43:29-32.

39. Baron J H, Connell A M, Lennard-Jones J E. Variation between observers in describing mucosal appearances in proctocolitis. BMJ 1964;1:89-92.

40. Cummings J H, Christie S, Cole T J. A study of fructooligosaccharides in the prevention of travellers' diarrhoea. Aliment Pharmacol Therap 2001;15:1139-45.

41. O'Neil D A, Cole S P, Martin-Porter E, et al. Regulation of human beta-defensins by gastric epithelial cells in response to infection with Helicobacter pylori or stimulation with IL-1. Infect Immun 2000;68:5412-15.

42. Stagg A J, Hart A L, Knight S C, et al. The dendritic cell: its role in intestinal inflammation and relationship with gut bacteria. Gut 2003;52:1522-29.

43. Rescigno M, Urbano M, Valzasina B, et al. Dendritic cells express tight junction proteins and penetrate gut epithelial monolayers to sample bacteria. Nat Immunol 2001;2:361-67.

What is claimed is:

1. A pharmaceutical composition comprising at least one microorganism and a carbon source for enabling growth of the at least one microorganism in the digestive tract of a subject to which the pharmaceutical composition is administered.

2. The pharmaceutical composition of claim 1, wherein the at least one microorganism tolerates conditions in which the oxygen content of the available atmosphere is low.

3. The pharmaceutical composition of claim 1, wherein the at least one microorganism is anaerobic or microaerophilic.

4. The pharmaceutical composition of claim 1, wherein the at least one microorganism is acid tolerant.

5. The pharmaceutical composition of claim 1, wherein the at least one microorganism is bile tolerant.

6. The pharmaceutical composition of claim 1, wherein the at least one microorganism is capable of binding and/or adhering to cells.

7. The pharmaceutical composition of claim 1, wherein the carbon source stimulates the growth of the at least one microorganism.

8. The pharmaceutical composition of claim 1, wherein the carbon source comprises a carbohydrate and a peptide.

9. The pharmaceutical composition of claim 1, wherein the carbon source is a carbohydrate.

10. The pharmaceutical composition of claim 1, wherein the carbon source is a non-absorbable polymer.

11. The pharmaceutical composition of claim 1, wherein the carbon source comprises fructo-oligosaccharides and inulin.

12. The pharmaceutical composition of claim 1, wherein the carbon source consists essentially of fructo-oligosaccharides and inulin.

13. The pharmaceutical composition of claim 1, wherein the pharmaceutical composition comprises a cocktail of microorganisms.

14. The pharmaceutical composition of claim 1, wherein the at least one microorganism is selected from the group consisting of Eschericia, Bacteroides, Lactobacillus, Clostridia and/or Bifidobacterium species.

15. The pharmaceutical composition of claim 1, wherein the at least one microorganism is Bifidobacterium longum.

16. The pharmaceutical composition of claim 1, comprising about 2×10⁵ to about 2×10¹² microorganisms per ml and/or about 1 to about 8 grams of carbon source.

17. A pharmaceutical composition consisting essentially of:
(a) Bifidobacterium longum;
(b) fructo-oligosaccharides;
(c) inulin; and
(d) a pharmaceutically acceptable carrier.

18. A method of treating a subject suffering from ulcerative colitis, said method comprising:
(a) administering a therapeutically effective amount of at least one microorganism to a subject; and
(b) administering a therapeutically effective amount of a carbon source to the subject; for enabling growth of the at least one microorganism in the digestive tract of the subject.

19. The method of claim 18, wherein the at least one microorganism and the carbon source are administered daily.

20. The method of claim 18, wherein the at least one microorganism and the carbon source are administered twice daily.

21. The method of claim 18, wherein the at least one microorganism and the carbon source are administered daily for about 14 to about 42 days.

22. The method of claim 18, wherein the patient suffering from ulcerative colitis is administered about 2×10⁵ to about 2×10¹² microorganisms per ml and/or about 1 to about 8 grams of the carbon source.

23. The method of claim 18, wherein the at least one microorganism is selected from the group consisting of Eschericia, Bacteroides, Lactobacillus, Clostridia and/or Bifidobacterium species.

24. The method of claim 18, wherein the at least one microorganism is Bifidobacterium longum.

25. The method of claim 18, wherein the carbon source stimulates the growth of the at least one microorganism.

26. The method of claim 18, wherein the carbon source is a non-absorbable polymer.

27. The method of claim 18, wherein the carbon source is a carbohydrate.

28. The method of claim 18, wherein the carbon source comprises fructo-oligosaccharides and inulin.

29. The method of claim 18, wherein the carbon source consists essentially of fructo-oligosaccharides and inulin.

30. The method of claim 18, wherein the at least one microorganism and the carbon source are administered separately.

31. The method of claim 18, wherein the at least one microorganism and/or the carbon source are encapsulated.

32. The method of claim 18, wherein the at least one microorganism and the carbon source are co-administered.

33. The method of claim 18, wherein the subject is human.

34. A method of treating a subject suffering from ulcerative colitis, said method comprising administering a pharmaceutical composition comprising at least one microorganism and a carbon source for enabling growth of the at least one microorganism in the digestive tract of the subject to which the composition is added, wherein the at least one microorganism is capable of modulating the production of cytokines from cells.

35. The method of claim 34, wherein the at least one microorganism modulates the production of proinflammatory cytokines.

36. The method of claim 35, wherein the proinflammatory cytokines are selected from the group consisting of IL-1α, TNF-α, Il-1β and Il-6.

37. The method of claim 34, wherein the subject is human.
